(19) United States
(12) Patent Application Publication
(10) Pub. No.: US 2025/0238850 A1
(43) Pub. Date: Jul. 24, 2025

(54) METHOD AND SYSTEM FOR RECOMMENDING PRODUCT BUNDLES

(71) Applicant: Target Brands, Inc., Minneapolis, MN (US)

(72) Inventors: Aparupa Das Gupta, San Francisco, CA (US); Anupama Joshi, San Francisco, CA (US); Gregory Olsen, St. Paul, MN (US); Samaneh Karimi, Houston, TX (US); Amit Pande, Ames, IA (US); David Relyea, Bothell, WA (US); Saloni Agarwal, Baltimore, MD (US)

(21) Appl. No.: 18/986,287

(22) Filed: Dec. 18, 2024

Related U.S. Application Data
(63) Continuation-in-part of application No. 17/531,399, filed on Nov. 19, 2021, now Pat. No. 12,211,081.
(60) Provisional application No. 63/633,488, filed on Apr. 12, 2024.

(51) Int. Cl. G06Q 30/0601

(52) U.S. Cl. CPC G06Q 30/0631; G06Q 30/0633; G06Q 30/0643

(57) ABSTRACT

Methods and systems for providing a product bundle recommendation are disclosed. One method includes receiving a selection of a first product at a retail website, and identifying the first product in a product graph generated from historical add to cart data. The method includes, identifying, in the product graph: one or more edges from the initial product to secondary products; one or more edges from a similar product to one or more secondary-similar products; and one or more inferred edges from the initial product to one or more inferred secondary products. The method further includes forming a set of recommended products from the one or more secondary products, the one or more secondary-similar products, and the one or more inferred secondary products, and presenting a bundled product recommendation selected from among the set of recommended products.

### CROSS-REFERENCE TO RELATED APPLICATION(S)

This application claims the benefit of U.S. Provisional Patent Application No. 63/633,488, filed Apr. 12, 2024, which is incorporated by reference herein in its entirety. This application is further a continuation-in-part of U.S. patent application Ser. No. 17/531,399, filed on Nov. 19, 2021, entitled “Method and System for Recommending Product Bundles,” which is incorporated by reference herein in its entirety.

### BACKGROUND

Retail websites, including pages displaying details regarding an individual item, often include product recommendations for other items or products a user may be interested in, to encourage a user to buy additional products while he or she visits the retail website. For example, a user may be presented with a list of products complementary to the product that is currently being viewed, or a user may be presented with a list of products similar to the product that is being viewed.

At times, a retailer may wish to adjust the recommendations presented to the user based on the product attributes associated with the product that a user is shopping for. For example, the retailer may wish to present complementary products in response to a user selecting a particular television that the user is considering for purchase (e.g., cables required for connecting to home stereo equipment, speaker systems, etc.). There is currently not a convenient way for retailers to adjust or filter product recommendations to provide a more meaningful experience to consumer users in accordance with adjustments desired by the retailer.

While retailers may, on occasion, prepare item recommendations for users that are based on past shopping preference and items that may be complementary to those shopped for, improvements in accuracy and completeness of such recommendations are desired. As such, new approaches are sought.

### SUMMARY

In general, the present disclosure relates to a product bundles recommendation server. An example system implementing a product bundles recommendation server may include a computing system including a data store, a processor, and a memory communicatively coupled to the processor. The memory stores instructions executable by the processor to: receive add to cart data, product price information, and product data for products offered at a retail website; form a product graph from the add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart; identify similar products within the product graph based, at least in part, on attributes of the products represented in the product graph; and determine inferred edges between pairs of nodes in the product graph based on a model trained using at least some of the plurality of edges as positive examples and node pairs lacking an edge therebetween as negative examples. The instructions further are executable to perform: receiving a selection of an initial product and identifying, in the product graph: one or more edges from the initial product to one or more secondary products; based on a similar product to the initial product existing within the product graph, one or more edges from the similar product to one or more secondary-similar products; and one or more inferred edges from the initial product to one or more inferred secondary products. The instructions are further executable to form a set of recommended products from at least some of the one or more secondary products, the one or more secondary-similar products, and the one or more inferred secondary products.

In a second example aspect, a method includes receiving a selection of a first product at a retail website, and identifying the first product in a product graph generated from historical add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart in the historical add to cart data. The method includes, identifying, in the product graph: one or more edges from the initial product to one or more secondary products; based on a similar product to the initial product existing within the product graph, one or more edges from the similar product to one or more secondary-similar products; and one or more inferred edges from the initial product to one or more inferred secondary products. The method further includes forming a set of recommended products from at least some of the one or more secondary products, the one or more secondary-similar products, and the one or more inferred secondary products, and presenting at least one bundled product recommendation on a user interface on the customer device as a recommendation for purchase with the initial product, the at least one bundled product recommendation being selected from among the set of recommended products.

In further aspects, example systems for providing a product recommendation on a retailer website are described. An example system includes a computing system including a data store, a processor, and a memory communicatively coupled to the processor. The memory stores instructions executable by the processor to: receive, from a customer device, a selection of a first product offered for sale via the retailer website; access the data store to retrieve customer add to cart data, product price data, and degree of diversity data, wherein: the customer add to cart data is based on historical customer shopping activity of a plurality of customers and includes data describing online shopping sessions in which products are selected for addition to historical shopping carts to which the first product was previously added, and the customer add to cart data further includes data describing an order in which the products are added to the historical shopping carts to which the first product was previously added; based on the selection of the first product and the customer add to cart data, generate a list of bundled products having a complementary relationship with the first product, wherein, in the historical customer shopping activity, the bundled products have been selected after the selection of the first product more than a threshold number of times; select at least one bundled product from the list of bundled products; and present the at least one bundled product on a user interface on the customer device as a recommendation for purchase with the first product.

In a further aspect, example methods for providing a product recommendation are described. An example method includes receiving, from a customer device, a selection of a first product offered for sale via a retailer website; accessing a data store to retrieve customer add to cart data, product price data, and degree of diversity data, wherein: the customer add to cart data is based on historical customer shopping activity and includes data describing online shopping sessions in which products are selected for addition to a historical shopping cart to which the first product was previously added, the customer add to cart data further includes data describing an order in which the products are added to the historical shopping cart to which the first product was previously added, and the degree of diversity data includes product similarity data including a product similarity score between two products based on a comparison of product attributes; based on the selection of the first product and the customer add to cart data, generating a list of bundled products, wherein the list of bundled products includes one or more additional products that have been selected after the selection of the first product in the historical customer shopping activity more than a threshold number of times; selecting at least one bundled product from the list of bundled products; and presenting the at least one bundled product on a user interface on the customer device as a recommendation for purchase with the first product.

In a further aspect, example systems for providing a product recommendation are described. An example system includes a computing system including a data store, a processor, and a memory communicatively coupled to the processor. The memory stores instructions executable by the processor to: receive, from a customer device, a selection of a first product offered for sale via a retailer website; access the data store to retrieve customer add to cart data, product price data, and degree of diversity data, wherein: the customer add to cart data is based on historical customer shopping activity and includes data describing online shopping sessions in which products are selected for addition to a historical shopping cart to which the first product was previously added, the customer add to cart data further includes data describing an order in which the products are added to the historical shopping cart to which the first product was previously added, and the degree of diversity data includes product similarity data having a product similarity score between two products based on a comparison of product attributes; based on the selection of the first product and the customer add to cart data, generate a list of bundled products, wherein the list of bundled products includes one or more additional products that, in the historical customer shopping activity, have been selected after the selection of the first product more than a threshold number of times; based on a price of the first product, generate a product recommendation price range; based on a product category of the first product, determine a degree of diversity for the product recommendation; select from the list of bundled products at least one bundled product, the selected at least one bundled product having a price within the product recommendation price range and meeting the determined degree of diversity; and present the at least one bundled product on a user interface on the customer device as a recommendation for purchase with the first product.

### BRIEF DESCRIPTION OF THE FIGURES

FIG. 1 illustrates an example environment in which the product bundles recommendation server may be implemented;

FIG. 2 illustrates a block diagram of an example architecture of the product bundles recommendation server, according to an example embodiment;

FIG. 3 illustrates a graphical representation of an example product relationship network, according to an example embodiment;

FIG. 4 illustrates another graphical representation of an example product relationship network, according to an example embodiment;

FIG. 5 illustrates an example flowchart for predicting product relationships within a product relationship network using a Graph Neural Network, according to an example embodiment;

FIG. 6 illustrates an example user interface displaying a recommended product bundle, according to an example embodiment;

FIG. 7 illustrates an example user interface displaying a recommended product bundle, according to an example embodiment;

FIG. 8 illustrates an example user interface displaying a recommended product bundle, according to an example embodiment;

FIG. 9 illustrates a flow diagram of an example method of recommending product bundles, according to an example embodiment;

FIG. 10 illustrates a flow diagram of an example method of filtering a product bundle, according to an example embodiment;

FIG. 11 illustrates a flow diagram of an example method of inferring complementary relationships to recommend a product bundle, according to an example embodiment;

FIG. 12 illustrates a flow diagram of another example method of inferring complementary relationships to recommend a product bundle, according to an example embodiment;

FIG. 13 illustrates a block diagram of an example computing device usable to implement aspects of the present disclosure.

FIG. 14 illustrates a flow diagram of an example method of identifying recommended products to be bundled with a selected product, according to a further example embodiment.

FIG. 15 illustrates a flow diagram of an example method of interacting with a user at a retail website to provide recommended products that may be bundled with a selected product, according to an example embodiment.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

As briefly described above, embodiments of the present invention are directed to a product bundles recommendation server that may be integrated with a retailer website. In particular aspects, the product bundles recommendation server allows a retailer to recommend complementary or bundled products to a user or a customer based on a user viewing a first item or product, also called a “seed product,” that is offered for sale on a retailer website. Additionally, the product bundles recommendation server allows a retailer to apply limiting factors or filters to further control the products within a bundle recommended to a user.

The product bundles recommendation server described herein allows the retailer to collect and analyze historical add to cart data including the order in which users place products in online shopping carts. Users may shop for products in a logical manner by adding a first product to a shopping cart followed by other products that are complementary to the first product. Thus, the first product drives the user to select the additional products. By tracking the order in which products are added to shopping carts, the server can identify which product drives a user to select other complementary products. Complementary relationships between products may be identified and used to generate a list of bundled products to present to a user based on a user first selecting a seed product. A wide range of controls provided by the server allows the retailer to provide product recommendations that are more meaningful to the user. For example, recommended product bundles may be meaningful in terms of pricing by including a price filter to ensure all recommended products within a bundle are priced similarly to (or in some logical relation to) a seed product that has been selected.

In some example implementations, a product graph may be formed and utilized to identify items recommended to be bundled with a first, or seed, product. The product graph may be generated from historical add to cart data in an online retail environment, for example being based on prior instances in which secondary products are added to a cart after a primary product has been added previously. The primary product, e.g., the first or seed product, may be within a same product category as the secondary items, and may be a product added first to a cart as compared to the secondary products. The primary product and secondary products may be included in a product graph and links by edges that are formed based on the add to cart data. For example, an edge may be formed if a primary product is added to a cart and a secondary product is added to the same cart more than a predetermined number of times within the add to cart data. Edges may be directed (e.g. from the first product to the second product, but not from the second product to the first product) based on the order the products are added to carts in the add to cart data, and are weighted based on the frequency or propensity with which the products appear in the same cart. Such weighting may be normalized, for example after all add to cart data is analyzed.

In some example implementations, to identify additional products that may be recommended for bundling with a first product, a similarity analysis may be performed between the first product and other products offered for sale via the retail website. Similar products may be identified based on similarity in attributes as determined from text or image descriptions of those products. An example methodology for identifying similar items as described in U.S. patent application Ser. No. 18/595,160, filed on Mar. 4, 2024, entitled “Similar Item Forecasting”, the disclosure of which is incorporated by reference herein in its entirety. Upon identification of such similar products, in some examples edges may be identified between the similar product and other secondary products. These other secondary products or “secondary similar products”, may be added to the collection of potentially recommended products, since it may be likely that products often bundled with the similar product may also be bundled with the initial product, due to the similarity between initial product and the similar product, and potentially similar purchasing patterns between those products.

In still further example implementations, additional inferred or predicted edges between nodes in the product graph may be identified, with such inferred edges from the first product to other products may suggest further inferred secondary products that may be included within product recommendations for bundling. Edges may be inferred based on a prediction of a probability that an edge may exist using node attributes and information associated with the product graph (e.g. existing node and edge information). In particular, a link prediction algorithm may be used based on graph neural networks (also referred to as GNNs) to generate predicted edges. In particular, existing edges may be used as positive samples, and randomly selected negative sample edges between unlinked pairs of products within the product graph may be used as training data, and a GNN may then predict which product relationships are plausible despite a lack of add to cart data.

In example implementations, the secondary products identified the edges in a product graph, the secondary similar products identified in the product graph based on edges connected from a similar product to the first product, and additional secondary products identified by inferred or predicted edges may be gathered into an overall collection of potential product recommendations for bundling with the first product. One or more sorting or filtering steps may be performed, for example based on price or other attributes of the product recommendations, degree of diversity between the first item and the potential product recommendation, and the like. A subset of those product recommendations may then be returned for use or display via the retail website, for potential selection by the user.

It is noted that in some implementations, the product graph as described above may correspond to products that all fall within a particular product category. In other implementations, the product graph may include items across product categories, for example where selected product categories may implicate products often purchased together (e.g., a picnic basket chosen from a home goods category and various snack foods, paper plates, and the like selected from a grocery items category).

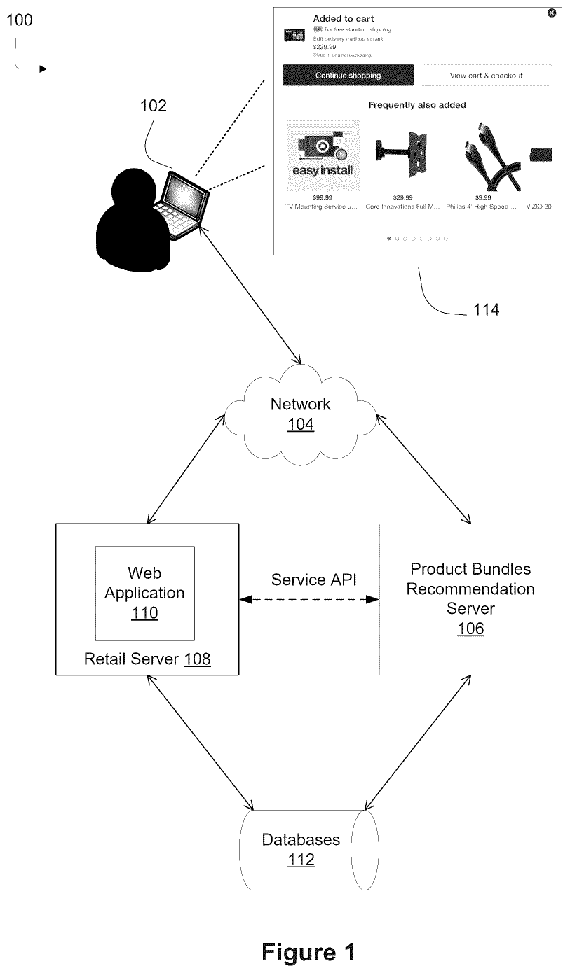

Referring first to FIG. 1, an example environment 100 in which the product bundles recommendation server may be implemented is displayed. In the example shown, a retail server 108 hosts a web application 110, such as an application that may be displayed on a customer device 102. The customer device 102, for example mobile or desktop computing devices, may access the web application 110 via a network 108, such as the Internet.

In an example embodiment, the web application 110 corresponds to a retailer website at which a user may shop for products. That is, a request to view a retailer website may be received at the web application 110 from a customer device 102. The web application 110 may then access databases 112 containing product information. The product information can include, for example, a plurality of products carried by the retailer and attributes associated with each product carried by the retailer. In general, the retail server 108, web application 110, and databases 112 are associated with a retail enterprise, and the customer device 102 is a computing device that is owned or controlled by a user or customer of the retailer.

In the example shown, the retail server 108 may access a product bundles recommendation server 106. The product bundles recommendation server 106 operates to provide product recommendations to be displayed on a retailer website after a user has selected a seed product. The product bundles recommendation server 106 communicates with one or more databases 112 to access product data, sales data, and/or data associated with the order in which users add products to an online shopping cart. Databases 112 may be external and updated in real time as new data and information becomes available. Based on data from databases 112, the product bundles recommendation server 106 generates a list of bundled products that are complementary to a seed product that a user has selected. In example embodiments, after the product bundles recommendation server 106 has generated a list of bundled products, limiting factors or filters may be applied to the list before any products are recommended to the user. For example, a filter may be applied to eliminate products from the list that do not have a price within a particular price range. After the list of bundled products has been generated and filtered, recommended product bundles may be sent through the network 104 to a customer device 102 where the recommended products may be presented on a display 114 of the customer device 102.

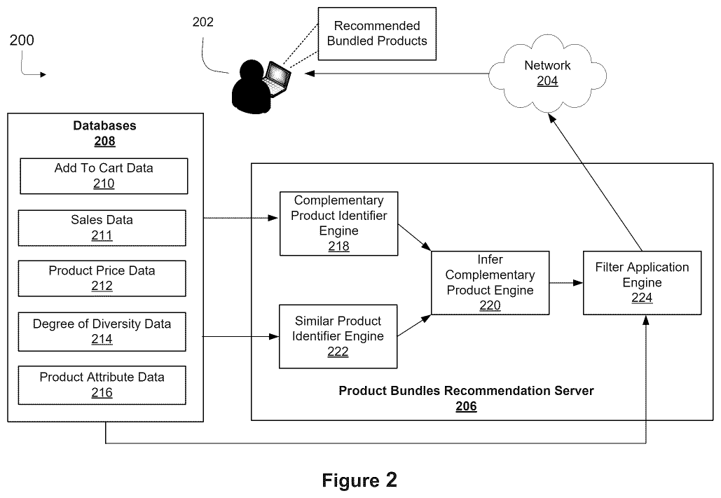

The product bundles recommendation server 106 may be configured to execute one or more algorithms or programs for generating a list of bundled products that are complementary to a seed product that has been selected by a user to add to his or her online shopping cart on a retailer website hosted by a retail server, (e.g., when viewed from a website or web application 110). In some examples, the product bundles recommendation server 106 may directly receive data usable by the algorithms or programs for generating lists of bundled products. In other examples, the product bundles recommendation server 106 may access pre-stored data, for example data stored at retail server 18 (or another server within a retail enterprise). In example embodiments, the product bundles recommendation server 106 may implement a plurality of different available recommendation algorithms. In such embodiments, the product bundles recommendation server 106 may be configured to display available recommendation algorithms that may be selected by an administrative user. The product bundles recommendation server 106 is described further below, for example, with respect to FIGS. 2-5.

FIG. 2 illustrates a block diagram of an example architecture 200 of the product bundles recommendation server, according to an example embodiment. In the example shown, information is stored in external databases 208, including, but not limited to, add to cart data 210, sales data 211, product price data 212, degree of diversity data 214, and product attribute data 216. Add to cart data 210 is based on historical customer shopping activity and includes data describing online shopping sessions in which products are selected for addition to historical shopping carts to which a seed product was previously added, for a variety of different customer users. The online shopping sessions may include sessions where any customer user made a purchase of at least one product. Add to cart data 210 further includes the order in which customers add products to a historical online shopping cart. In some examples, the add to cart data includes timestamps corresponding to the time at which products are added to a historical shopping cart. Product price data 212 includes pricing information associated with each product offered for sale by the retailer.

Degree of diversity data 214 includes category information associated with each product offered for sale by the retailer. For example, each product may be categorized into at least one category. Examples of such categories include grocery, household essentials, clothing, baby, electronics, kitchen and dining, personal care, and pets. For each category, the degree of diversity data 214 includes an associated degree of diversity score. The degree of diversity score reflects the amount of diversity or variance to include in a product bundle recommended to a user. More specifically, the degree of diversity score associated with a seed product's category may determine the level of diversity of the product bundle recommended to a user. For example, if a user selects a seed product that is categorized into a category with a high degree of diversity score, or a degree of diversity above a predetermined threshold, the product bundle recommended to the user will include products that are more diverse from the seed product. In examples, the electronics category may have a high degree of diversity score. For example, a user who selects a television as a seed item may be more likely to purchase additional products that are diverse from the television (e.g., cables, remote, television mount), versus additional products that are similar to the television (e.g., a television made by a different manufacturer or having a different screen size). Similarly, in examples, the grocery category may have a lower degree of diversity score. For example, a user who indicates interest in a package of vanilla yogurts may be more likely to purchase additional products that are similar to the yogurt (e.g., blueberry yogurts), versus additional products that are diverse from the yogurt (e.g., pasta), so those similar products might be appropriate to be presented as potentially bundled for purchase with the originally-selected item. The product similarity score may be generated by comparing product attributes using product attribute data 216. Product attribute data 216 includes information about each product offered for sale by a retailer.

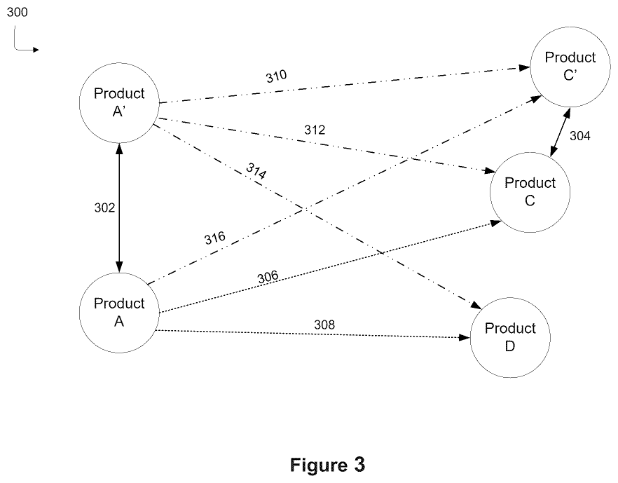

In the example shown, the product bundles recommendation server 206 may include a complementary product identifier engine 218, a similar product identifier engine 222, and an infer complementary product engine 220. The functionality of the complementary product identifier engine 218, the similar product identifier engine 222, and the infer complementary product engine 220, are described in more detail below, for example, with respect to FIGS. 3-5. The complementary product identifier engine 218 receives add to cart data 210 and identifies trends in the order in which diverse customer users add products to their respective historical shopping carts. In examples, if a threshold number of users who first added a seed product to a historical shopping cart also added a second product to the historical shopping cart, the second product is identified as complementary to the seed product. For example, if a threshold number of customers who first added a particular car seat to their shopping cart also added a particular backseat mirror to their shopping cart, then the complementary product identifier engine 218 may identify the car seat and the backseat mirror as complementary products.

In the example shown, the similar product identifier engine 222 receives data from the databases 208 to identify products that are similar to one another. In examples, the similar product identifier engine 222 may compare product attribute data 216 for two products and determine a product similarity score. If the product similarity score is above a predetermined threshold, the similar product identifier engine 222 may identify the two products as similar such that they can be substituted with one another. In examples, if the product similarity score for two products is above a predetermined threshold, as determined by the similar product identifier engine 222, one product may be substituted with the other product, if, for example, one product is out of stock.

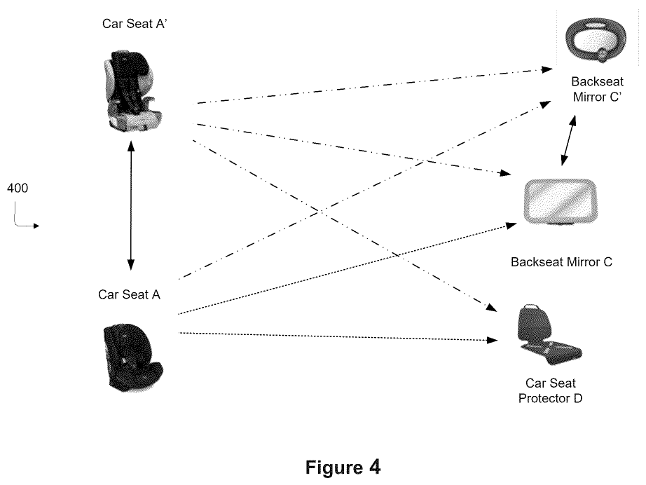

The infer complementary product engine 220 receives information on complementary products from the complementary product identifier engine 218 and information on similar products from the similar product identifier engine 222 to predict and infer complementary relationships between products. Based on known and inferred complementary relationships between products, a list of complementary products may be generated. The infer complementary product engine 220 is described below in more detail, for example, with respect to FIG. 3 and FIG. 4.

In examples, the complementary product identification engine 218, and in further cutlery product engine 220 may be implemented using graph neural networks, and product graphs having nodes corresponding to products and edges corresponding to relationships between those products. The similar product identification engine 222 may utilize one or more other algorithms and or models to identify similar products, as described above and in U.S. patent application Ser. No. 18/595,160 previously incorporated by reference.

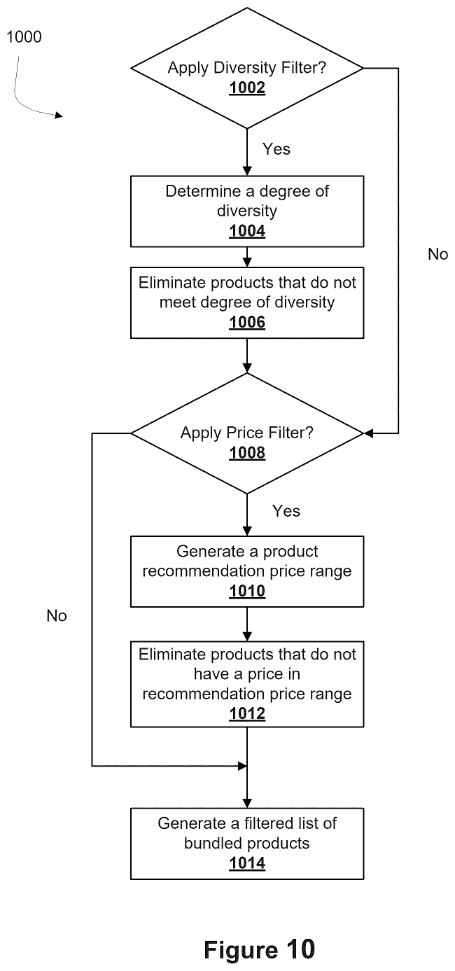

The list of complementary products can be transmitted from the infer complementary product engine 220 to a filter application engine 224, where limiting factors or controls may be applied to the list of complementary products. The operation of the filter application engine 224 is described in more detail below, for example, with respect to FIG. 10. The filter application engine may access the databases 208. In an example, one filter that may be applied by the filter application engine 224 to the list of complementary products is a degree of diversity filter. To apply the degree of diversity filter, the filter application engine 224 may access the degree of diversity data 214 and determine a degree of diversity for the product recommendation based on the category of the seed product. The filter application engine 224 may then eliminate any products from the list of complementary products that do not meet the determined degree of diversity. In another example, one filter that may be applied by the filter application engine 224 to the list of complementary products is a price filter. To apply the price filter, the filter application engine 224 may access product price data 212 and generate a product recommendation price range based on the price of the seed product. In examples, the product recommendation price range may include prices above and below the price of the seed product. In other examples, the upper limit of the product recommendation price range may be the price of the seed product, such that no recommended products are more expensive than the seed product. The filter application engine 224 may eliminate any products from the list of complementary products that do not have a price within the product recommendation price range.

In examples, the filter application engine 224 may apply more than one filter to the list of complementary products. For example, the filter application engine 224 may apply both a degree of diversity filter and a price filter, such that the complementary products remaining on the list after the filters are applied are within a determined degree of diversity and also have prices within a determined price range.

In the example shown, after a list of complementary products has been identified and any applicable filters applied by the filter application engine 224, at least one complementary product from the list may be transmitted over a network 204 to a customer device 202, where the at least one complementary product may be presented on a user interface of the customer device 202 as a recommendation of a product to bundle for purchase with a seed product.

FIG. 3 is a graphical representation of a product relationship network 300, according to an example embodiment. FIG. 3 further illustrates a graphical representation of product relationships determined by the complementary product identifier engine 218, the similar product identifier engine 222, and the infer complementary product engine 220. The product relationship network 300 include a plurality of nodes, where each node represents a product offered for sale by a retailer. Each link or edge between nodes represents a relationship or interaction between two products. The product relationship network 300 maintains a plurality of edges between a plurality of nodes, including complementary relationships, similarity relationships, and inferred complementary relationships as determined by the complementary product identifier engine 218, the similar product identifier engine 222, and the infer complementary product engine 220.

In the example shown, the similar product identifier engine 222 has determined that Product A and Product A′ have a similarity score above a predetermined threshold, so there is a similar product link or edge 302 between Product A and Product A′. The similar product identifier engine 222 has also determined that Product C and Product C′ have a similarity score above a predetermined threshold, so there is a similar product link 304 between Product C and Product C′. In the example shown, the complementary product identifier engine 218 has determined that, based on Product C being added to a historical shopping cart by customers who previously added Product A more than a threshold number of times, Product A and Product C are complementary products, so there is a complementary product link or edge 306 between Product A and Product C. Similarly, the complementary product identifier engine 218 has determined that, based on Product D being added to a historical shopping cart by customers who previously added Product A more than a threshold number of times, Product A and Product D are complementary products, so there is a complementary product link 308 between Product A and Product C.

In the example shown, links 310, 312, 314, and 316 are edges or links generated by the infer complementary product engine 220 based on the similar product links determined by the similar product identifier engine 222 and the complementary product links determined by the complementary product identifier engine 218. The infer complementary product engine 220 is able to infer product relationships based on the existence of links between other pairs of products already present in the network 300 to identify additional links in the network of products 300. Specifically, the complementary product identifier engine 222 is configured to infer direct complementary relationships between two nodes within the product relationship network 300 based on the two nodes being connected by a multi-step path. For example, because Product A and Product C were determined to be complementary products, and because Product A and Product A′ were determined to be similar products, the infer complementary product engine 220 infers that Product A′ and Product C are complementary products. Thus, based on the first link between Product A and Product C, and the second link between Product A and Product A′, a complementary product link 312 is inferred between Product A′ and Product C. By training on existing product relationships to infer additional relationships and hidden links in the network 300, the product bundles recommendation server is more scalable and efficient, and increases the reach of potential recommendations to items where data representative of complementary or similar products may otherwise be sparse.

In further examples, links, or edges, may be performed based on add to cart data for each of the products illustrated in the graph of FIG. 3. In this example, Product A is linked via an edge to Products C and D, but not to Product C′. Concurrently, Product A′ may be linked via an edge to Products C, C′ and D. Based on similarity between Product A and Product A′, Product C′ may be considered complementary to Product A, given the established edge from Product A′ to Product C′, combined with item similarity. In addition, other inferred edges between Product A and other products may be determined, for example based on training and prediction within the product graph as illustrated. In particular, each of the edges or links between products as shown in FIG. 3 may be used as positive training data, and other non-existing edges or links between product nodes may be used as negative examples to retrain across all possible pairs of products within the product graph, in combination with node similarities. Accordingly, still further edges or links may be inferred directly between a first node (e.g., Product A) and other complementary nodes associated with other products (e.g., a hypothetical Product E not linked via add to cart data to either Product A or similar items such as Product A′). Accordingly, despite products never being added to the same cart in historical add to cart data, links between such products may be inferred and those items may be recommended. Such an arrangement is described in further detail below in conjunction with FIGS. 4, 14-15.

FIG. 4 is another graphical representation of a product relationship network 400, according to an example embodiment. FIG. 4 illustrates complementary relationships, similar relationships, and predicted complementary relationships as determined by the complementary product identifier engine 218, the similar product identifier engine 222, and the infer complementary product engine 220. In the example shown, the similar products identifier engine 222 has determined that two different car seats A, A′ are similar products, based on product attributes associated with both car seats. The similar products identifier engine 222 has also determined that two different back seat mirrors C, C′ are similar products. The complementary product identifier engine 318 has determined that backseat mirror C and car seat protector D are both complementary products to car seat A based on historical customer shopping activity indicating that more than a threshold number of customers who first added car seat A to their online shopping cart also added backseat mirror C or car seat protector D. In the example shown, based on the similar product links and the complementary product links, the infer complementary product engine 220 has inferred multiple additional complementary relationships. Specifically, the infer complementary product engine 220 has inferred that backseat mirror C′, backseat mirror C, and car seat protector D are complementary products to car seat A′. Additionally, the infer complementary product engine 220 has inferred that backseat mirror C is a complementary product to car seat A.

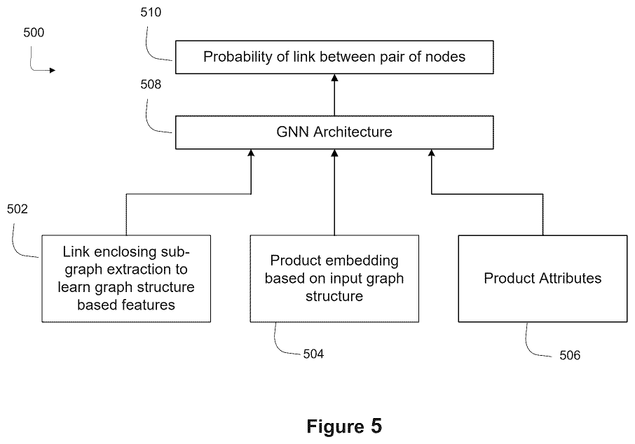

FIG. 5 illustrates an example flowchart 500 for inferring or predicting product relationships within a product relationship network using a Graph Neural Network (GNN). The example flowchart as shown in FIG. 5 may be carried out by the infer complementary product engine 220. In the examples describe herein, a machine-learning model may include one or more GNNs configured to learn an edge function between nodes within a fully-connected network. For example, a model may be trained using existing edges or links determined from add-to-cart data in order to predict the probability of an edge or link between two nodes within the network for which an edge is not otherwise derived directly from the add to cart data. A hidden state of each node evolves over time by exchanging information with its neighboring nodes via message passing. Weights in the model are shared across nodes, which gives the model the ability to handle a different number of inputs, which is relevant because the number of products in a recommended bundle can vary. Such weighting may be normalized, for example after all add to cart data is analyzed.

In some examples, the GNN may be trained via a framework that predicts links/relationships where one does not explicitly exist in the training data (for example, in the historical add to cart data or historical sales data). An example of such a framework is a learning from Subgraphs, Embeddings, and Attributes for Link prediction. Training data may be generated using existing edges as positive samples and an equal number of randomly chosen made-up edges as negative samples. This training data is utilized to predict if two nodes are connected at two edges (where at least one edge was present in an original product bundle graph). The model (GNN) learns to predict product relationships, even if two items have never been added to a cart together (or purchased together, in some examples) and the items' embeddings did not immediately suggest similarity. This may result in a comparatively larger graph that includes both real and predicted product relationships. In examples, the connections in the resulting graph may be used to generate a list of potential products for each initial product's recommended bundle.

In the example shown, input features 502, 504, and 506 are provided to the GNN architecture 508 to output a probability of a link existing between a pair of nodes 510. Specifically, the example framework 500 may process a representation of a set of products as a graph with each node in the graph representing a product and each edge representing a relationship between products. A machine-learning model may include a GNN model that includes an extraction layer 502 configured to convert a plurality of products and product relationships into an initial graph. Thus, graph structures are learned and extracted based on known products and relationships. The GNN model may further include a product embedding layer 504 to learn vector representations of nodes in the graph and improve prediction of links. Additional details of the architecture and use of GNNs, extraction layers, and embeddings for link prediction are provided in U.S. patent application Ser. No. 16/858,361 and U.S. patent application Ser. No. 16/855,761, which are hereby incorporated by reference in their entirety. Still further details regarding use of such a GNN for link prediction are described in Zhang et al., “Link Prediction Based on Graph Neural Networks”, 32nd Conference on Neural Information Processing Systems (NIPS 2018), the disclosure of which is hereby incorporated by reference in its entirety.

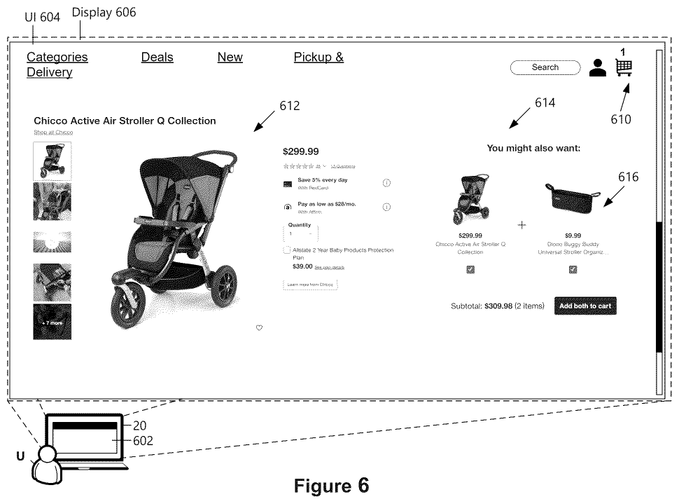

Now referring to FIGS. 6-8, various user interfaces are displayed. Generally, the user interfaces may be presented on a screen 602 of a computing device 20 via a user interface 604. In examples, the user interface 604 is presented on a display 606 such as a touch screen display.

FIG. 6 illustrates an example user interface 604 displaying a recommended product bundle 614 according to an example embodiment. In the example shown, a user U has selected a seed product 612, and in response, is presented a product detail page specific to that seed product. Based on the user selecting the seed product 612 and viewing the user interface 604, a product bundle 614 may be presented. In this example, the product bundle 614 is present alongside the seed product 612. The product bundle includes a product 616 complementary to the seed product 612 as determined by the product bundles recommendation server. In other examples, a product bundle may be presented as a pop-up window that is displayed in response to a user added a seed product to his or her online shopping cart. In this example, the user is presented with an option to add the entire product bundle to the online shopping cart. The price associated with each product is further presented on the user interface 604. The total price associated with the entire product bundle may also be presented on the user interface 604.

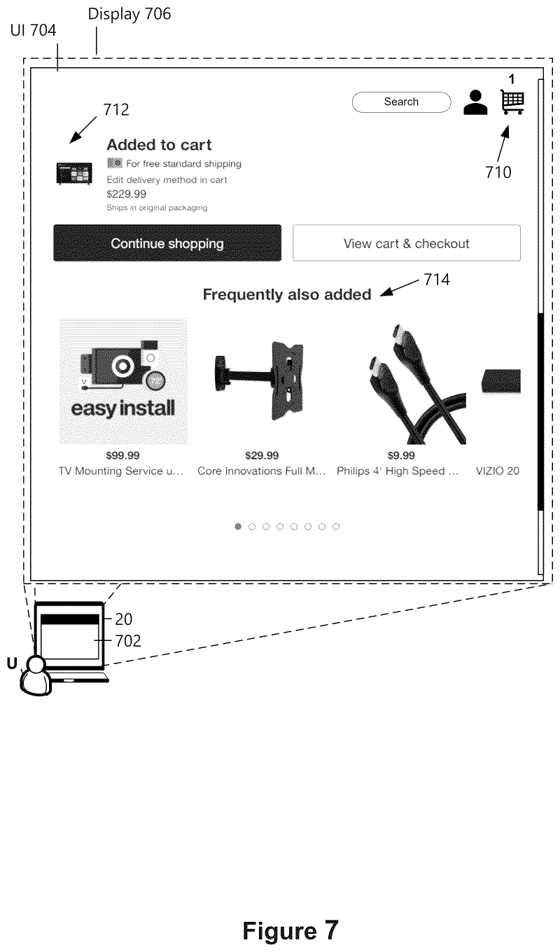

FIG. 7 illustrates another example user interface 704 displaying a recommended product bundle 714 according to an example embodiment. In the example shown, a user U has selected a seed product 712, for example by adding the seed product to his or her online shopping cart 710. Based on the user selecting the seed product 712 by adding the seed product 712 to the online shopping cart 710, a product bundle 714 is presented. In this example, the product bundle 714 includes a plurality of products complementary to the seed product 712. Moreover, the product bundle 714 includes a diverse grouping of products. The seed product in this example is a television, and the complementary products presented on the user interface include, for example, a TV mounting service, a TV wall mount, and an accessory cable. Each complementary product within the product bundle 714 may be selected, and a user may be redirected to a product page for the selected product. In other examples, the user may be able to select each complementary product within the product bundle 714 to add to his or her online shopping cart 710 with a single click and without first visiting the product detail page for each complementary product. This improves the overall shopping process, and the efficiency of that process, by removing the requirement of additional navigation steps by a customer and removing the burden of generating additional web pages/user interfaces on behalf of the retail website.

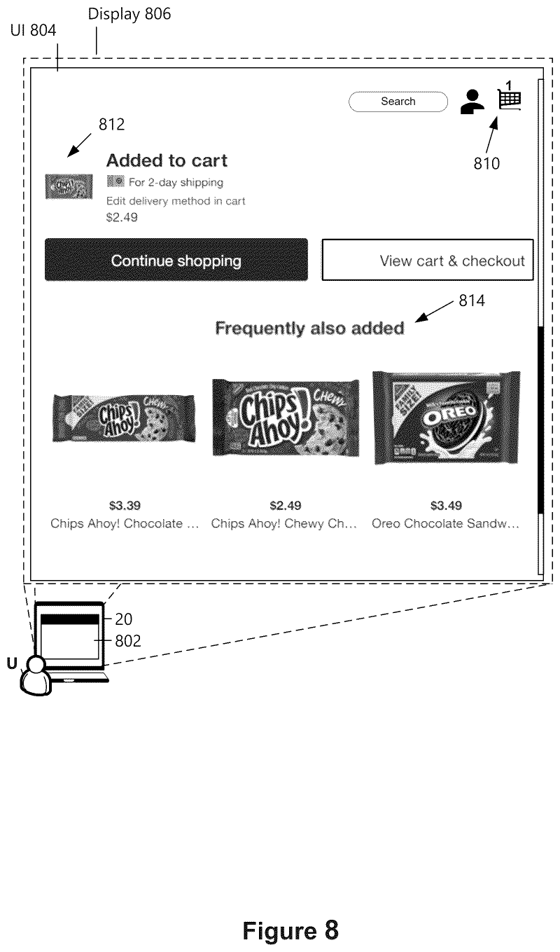

FIG. 8 illustrates another example user interface 804 displaying a recommended product bundle 814 according to an example embodiment. In the example shown, a user U has selected a seed product 812 to add to his or her online shopping cart 810. Based on the user U selecting the seed product, e.g., in this example by adding the seed product 812 to the online shopping cart 810, a product bundle 814 is presented. In this example, the product bundle 814 includes a plurality of products complementary to the seed product 712. Moreover, the product bundle 814 shown in this example includes a less diverse grouping of products. The seed product in this example is a package of cookies, and the complementary products presented on the user interface include, for example, other types of cookies.

Referring to FIGS. 6-8, it is noted that if the user U would add the seed product 612 to his or her cart 610, and subsequently add one or more product 616 from the product bundle 614, the add to cart data will be registered and the product bundle relationship between product 612, 616 may be strengthened for that user and other users when viewing the product detail page illustrated in the user interface 604. Similarly, addition of seed products 712, 812 to the cart will result in supplementing add to cart data, with products subsequently added to the cart being potentially considered as complementary to the initial or seed product.

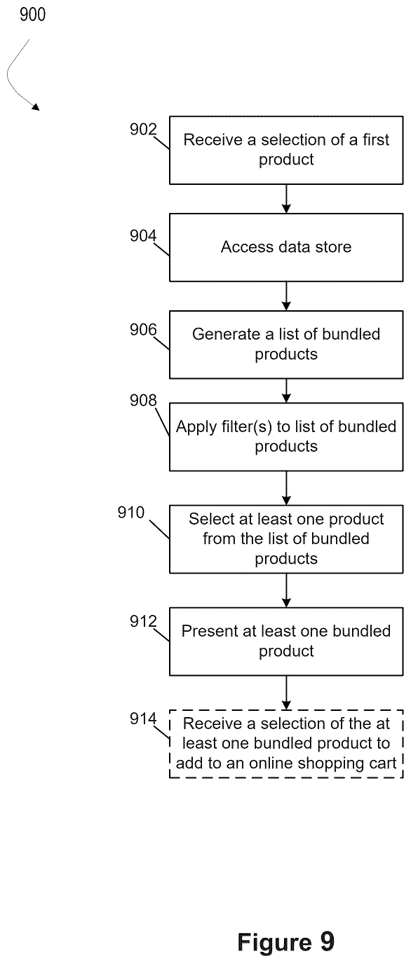

FIG. 9 illustrates a flow diagram of an example method 900 of recommending product bundles, according to an example embodiment. The method 900 may be performed, for example, by the product bundles recommendation server 106. Other networked structures may be used to implement aspects of the method 900 as well.

In the example shown, the method 900 includes receiving a selection of a first product, at operation 902. The selection is received from a customer device, which may be operated by a customer who is shopping on a retailer website. The first product is a seed product that drives the determination of what products to recommend to a customer in a product bundle. Once a first product is selected, for example by either viewing a product detail page of that product or by adding the product to the online shopping cart, a data store is accessed, at operation 904. Accessing the data store may include retrieving customer add to cart data, product price data, and degree of diversity data. The customer add to cart data is based on historical customer shopping activity and includes data describing online shopping sessions in which products are selected for addition to a historical shopping cart to which the first product was previously added. The customer add to cart data further includes data describing an order in which the products are added to the historical shopping cart to which the first product was previously added. The degree of diversity data includes product similarity data having a product similarity score between two products based on a comparison of product attributes. Based on the selection of the first product and the customer add to cart data, a list of bundled products is generated, at operation 906. The list of bundled products is generated by the product recommendation server. The list of bundled products includes a list of products that are complementary to the first product. Complementary products are identified by the complementary product identifier engine 218 and the infer complementary product engine 220 as described above, for example, with respect to FIGS. 2-5.

In examples, limiting factors or filters may be applied to the list of bundled products, at operation 908. Example filters that may be applied to the list of bundled products are described in more detail below with respect to FIG. 10. In the example shown, at least one product is selected from the list of bundled products, at operation 910. The selected product(s) from the list of bundled products is presented on a user interface on the customer device, at operation 912. Example user interfaces presented with product bundles are depicted in FIGS. 6-8. In examples, the at least one bundled product is presented alongside the first product, such that a customer can see both the seed product and the recommended product on a retail webpage. In examples, after at least one bundled product has been presented on the customer device, a selection of the at last one bundled product may be received to add the at least one bundled product to the shopping cart, at operation 914. When the at least one bundled product is selected to add to the online shopping cart, the add to cart data may be updated with information regarding the relationship between the first product and the at least one bundled product.

FIG. 10 illustrates a flow diagram of an example method 1000 of filtering a product bundle, according to an example embodiment. The method 1000 may be performed, for example, by the filter application engine 224. The method 1000 may be performed as one implementation of operation 908 of the example method 900 described above with respect to FIG. 9. In the example shown, a determination of whether to apply a degree of diversity filter to the list of bundled products is made, at operation 1002. If it is determined that a degree of diversity filter should be applied, then a degree of diversity is determined, at operation 1004, based on a product category of the first product. Category information may be included in the degree of diversity data 214 stored in the databases 208. At operation 1006, based on the determined degree of diversity, products on the list of bundled products that do not meet the determined degree of diversity are eliminated from the list of bundled products.

In the example shown, a determination of whether to apply a price filter to the list of bundled products is made, at operation 1008. If it is determined that a price filter should be applied, then a product recommendation price range is generated, at operation 1010. The product recommendation price range may be generated using product price data 212 stored in a database 208. In examples, the recommendation price range may include prices above and below the price of the first product. In other examples, the upper limit of the recommendation price range may be the price of the first product such that none of the recommended products in the product bundle are more expensive than the first product. For example, if a user adds a car seat with a price of $300 to his shopping cart, a price filter may be applied to the list of bundled products and the product bundle presented to the user may only include items that cost less than $300. This is because, typically, a customer will not choose as a secondary, or bundled product, a product that is more expensive than the product that the customer is initially seeking to buy.

At operation 1012, based on the recommendation price range, products on the list of bundled products that do not have a price within the recommendation price range are eliminated from the list of bundled items. In examples, both a diversity filter and a price filter may be applied. When both a diversity filter and a price filter are applied, the resulting list of bundled products will only include items that meet the determined degree of diversity and have a price within the recommendation price range. In other examples, only one filter is applied. In even other examples, no filter is applied. After any filters are applied, a filtered list of bundled products is generated, at operation 1014. When a filter or filters are applied to a list of bundled products, at operation 910 as described above with respect to FIG. 9, selecting at least one product from the list of bundled products may include selecting at least one product from the filtered list of bundled products, as generated at operation 1014.

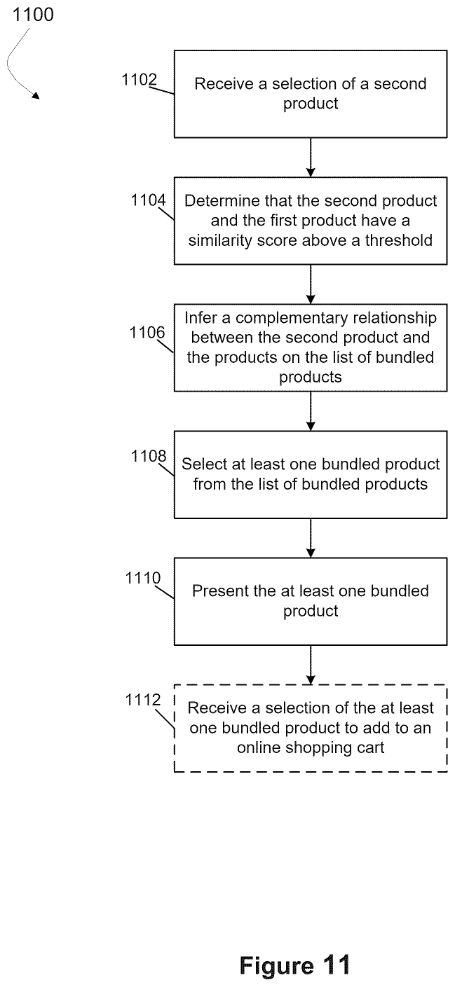

FIG. 11 illustrates a flow diagram of an example method 1100 of inferring complementary relationships to recommend a product bundle, according to an example embodiment. The example method 1100 may be carried out to generate a product relationship network, such as the product relationship network 300 depicted in FIG. 3, in order to recommend a product bundle. The list of bundled products generated in method 900 at operation 906 based on the first product being selected may also be used within method 1100.

In the example shown, a selection of a second product is received, at operation 1102. The similar product identifier engine 222 may then determine that the second product and the first product have a product similarity score above a predetermined threshold, at operation 1104. The product similarity score may be based on a comparison of product attributes stored in the product attribute data 216. Based on the first product and the second product having a product similarity score above a predetermined threshold, the similar product identifier engine 222 may generate a similar product link between the first product and the second product in a product relationship network. At operation 1106, the infer complementary product engine 218 infers a complementary relationship between the second product and the products on list of bundled products generated at operation 906, based on the similar product link between the first product and the second product. At least one bundled product from the list of bundled products may then be selected, at operation 1108, and presented on the user interface, at operation 1110, alongside the second item. In examples, a selection of the at least one bundled product to add to the shopping cart may be received, at operation 1112.

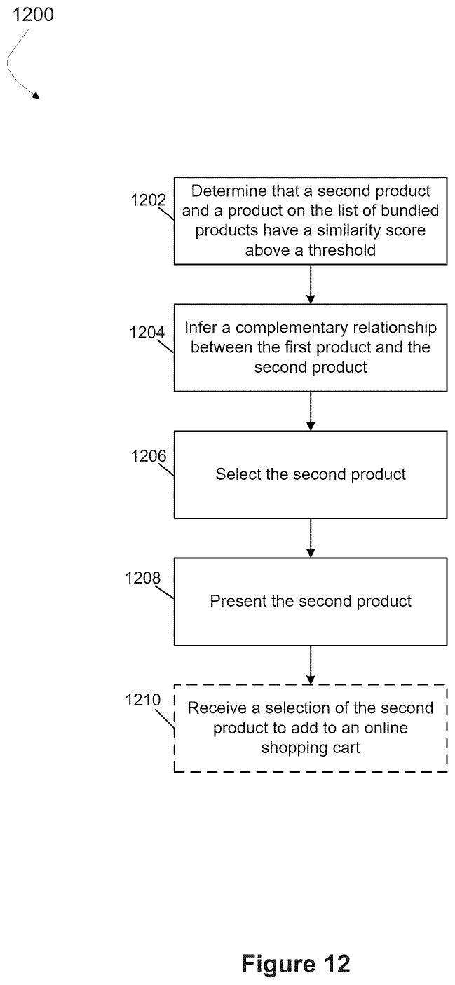

FIG. 12 illustrates a flow diagram of another example method 1200 of inferring complementary relationships to recommend a product bundle, according to an example embodiment. The example method 1200 may also be carried out to generate a product relationship network, such as the product relationship network 300 depicted in FIG. 3, in order to recommend a product bundle. The list of bundled products generated in method 900 at operation 906 based on the first product being selected may also be used within method 1200. As noted above, selection of the first product may include selecting the product for display on a product detail page, or selection to add the first product to a shopping cart.

In the example shown, based on product similarity data, a determination is made as to whether the product similarity score between a second product and a product on the list of bundled products generated in method 900 at operation 906 meets a predetermined product similarity score threshold, at operation 1202. If the threshold is met, a complementary relationship is inferred between the first product and the second product, at operation 1204. Based on the first product being added to an online shopping cart and the inferred complementary relationship between the first product and the second product, the second product is selected to recommend as a bundled product with the first product, at operation 1206. The second product is then presented on the user interface on the consumer device alongside the first product, at operation 1208. In examples, a selection of the second product may be received, at operation 1210. The selection may be to view the second product, or in some instances, to add the second product to the cart without having to first visit a product detail page of the second product.

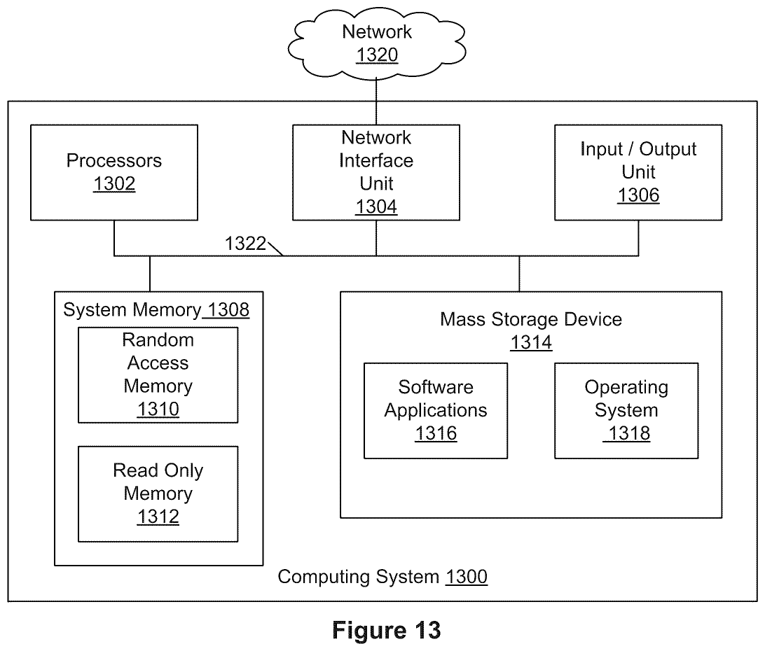

FIG. 13 illustrates an example block diagram of a virtual or physical computing system 1300. One or more aspects of the computing system 1300 can be used to implement the product bundles recommendation server 106, retail server 108, or other computing systems described above in conjunction with FIG. 1.

In the embodiment shown, the computing system 1300 includes one or more processors 1302, a system memory 1308, and a system bus 1322 that couples the system memory 1308 to the one or more processors 1302. The system memory 1308 includes RAM (Random Access Memory) 1210 and ROM (Read-Only Memory) 1312. A basic input/output system that contains the basic routines that help to transfer information between elements within the computing system 1300, such as during startup, is stored in the ROM 1312. The computing system 1300 further includes a mass storage device 1314. The mass storage device 1314 is able to store software instructions and data. The one or more processors 1302 can be one or more central processing units or other processors.

The mass storage device 1314 is connected to the one or more processors 1302 through a mass storage controller (not shown) connected to the system bus 1322. The mass storage device 1314 and its associated computer-readable data storage media provide non-volatile, non-transitory storage for the computing system 1300. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1300.

According to various embodiments of the invention, the computing system 1300 may operate in a networked environment using logical connections to remote network devices through the network 1320. The network 1320 is a computer network, such as an enterprise intranet and/or the Internet. The network 1320 can include a LAN, a Wide Area Network (WAN), the Internet, wireless transmission mediums, wired transmission mediums, other networks, and combinations thereof. The computing system 1300 may connect to the network 1320 through a network interface unit 1304 connected to the system bus 1322. It should be appreciated that the network interface unit 1304 may also be utilized to connect to other types of networks and remote computing systems. The computing system 1300 also includes an input/output controller 1306 for receiving and processing input from a number of other devices, including a touch user interface display screen, or another type of input device. Similarly, the input/output controller 1306 may provide output to a touch user interface display screen or other type of output device.

As mentioned briefly above, the mass storage device 1314 and the RAM 1310 of the computing system 1300 can store software instructions and data. The software instructions include an operating system 1318 suitable for controlling the operation of the computing system 1300. The mass storage device 1314 and/or the RAM 1310 also store software instructions, that when executed by the one or more processors 1302, cause one or more of the systems, devices, or components described herein to provide functionality described herein. For example, the mass storage device 1314 and/or the RAM 1310 can store software instructions that, when executed by the one or more processors 1302, cause the computing system 1300 to receive and execute managing network access control and build system processes.

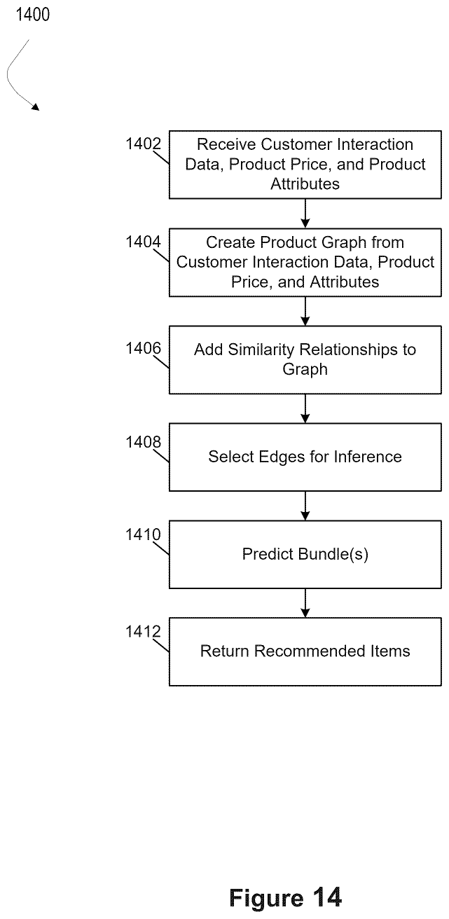

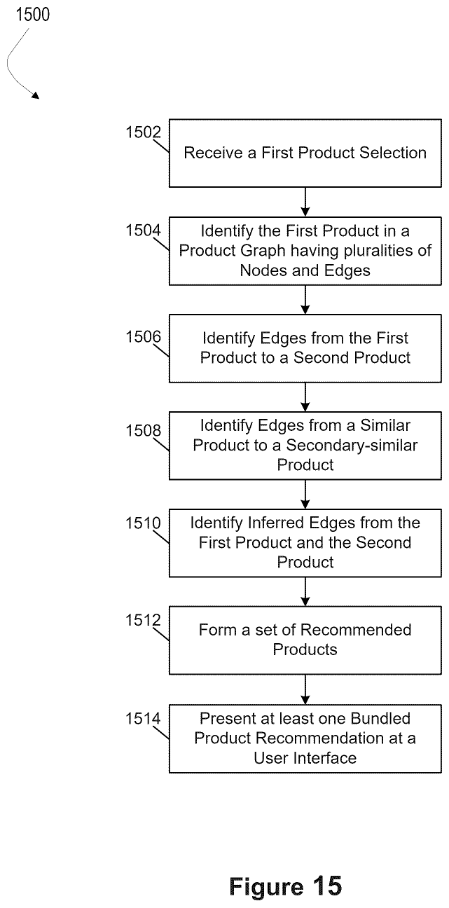

Referring now to FIGS. 14-15, further details regarding identification of complementary products are illustrated, in conjunction with further example aspects of the present application. The identification of complementary products may be implemented within the context of an online product selection, such as may be offered by an online retailer, in order to provide personalized data-based recommendations. One strategy used when recommending products to customers is to place multiple recommended products in a single bundle, as noted above. Bundled product recommendations enhance the shopping experience by allowing customers to quickly view and purchase products that are typically purchased together, such as a television and mount, or a razor with associated blades. In the context of certain websites, such complementary items may be presented within a region of a screen having a label “Frequently Bought Together” or “Compatible Items”. Non-limiting examples of such items are described and illustrated in FIGS. 4 and 6-8.

While certain versions of the compatible product recommendations processes described above provide highly popular recommendations to customers, there may be instances in which the overall item space is limited, or in which items may be too similar to each other to be likely to be purchased together (e.g., a stroller and another variant of a stroller, for example), or two different types of camera film for the same camera. In that example, while the camera and film may be purchased together, it may be unlikely that the two different types of film may be purchased together. Methods and systems are described that identify additional potential recommended products, and surface/filter more relevant products to the initial product selected.

FIG. 14 illustrates a flow diagram of an example method 1400 of identifying recommended products to be bundled with a selected product, according to a further example embodiment. The method 1400 may be implemented at a computing system implementing a product bundles recommendation server, in accordance with embodiments described herein.

In the example shown, the method 1400 includes receiving customer interaction data, product price information, and product attribute information (step 1402). The customer interaction data may include purchase data and other add to cart data, which reflects products added to a cart by a user, as well as the order in which those items are added, in an online retail environment. The product attribute information may include a category of the product, or may include a product description including image data and text data describing the product, or some combination thereof. The product price information and product attribute information may be received in association with each item offered for purchase within an online environment, or may include all items for which bundling is considered (e.g., all items within a given category).

In the example shown, the method 1400 further includes creating a product graph from the customer interaction data, product price, and product attributes. The product graph may be created for each product category (e.g., “kitchen” and the like). Each graph is created with nodes representing products in the category, and edges representing relationships between the products. Each edge between two products considers both the count and order of joint purchases and/or adds to cart of the product pair. Accordingly, graph edges between node pairs are weighted and directed.

In an example of graph creation, a customer may have added four products to their cart: bodysuits, baby socks, a mixing bowl, and a whisk, respectively, in that order. Based on this cart, an edge may be formed in a Clothing category graph (if one didn't already exist) from bodysuits to baby socks, {(bodysuits, socks)} E Clothing, and we then increase its weight by one. We do the same in the Kitchen category graph from the mixing bowl to the whisk, {(mixing bowl, whisk)} E Kitchen. After the graph is populated with all guest joint purchases and adds-to-cart (over a specific time period), its edge weights are normalized and the graph is reduced by removing edges whose weights fall below a threshold. An example product graph is generated as illustrated, for example in FIG. 3, in which products A, A′, C, C′, and D are included, and direct edges 306, 308, 310, 312, and 314 are formed from add to cart and purchase data.

In the example shown, the method further includes expanding the graph by leveraging product linkages predicted by identification of similar items (step 1406). In this process, the link between two products, such as Product A and Product A′ of FIG. 3, may be formed (e.g., link 302). In the example of two similar car seats as primary products, each car seat may have different accessories often sold with it; by identifying the two car seats as similar, accessories often sold with one of them may be identified as possible recommended items to be sold with the other. In examples, the identification of similar items may be performed by creating a distinct graph for each category where the edges represent an extent of similarity. Such a graph creation is described in U.S. patent application Ser. No. 18/595,160, which is hereby incorporated by reference in its entirety. These similarity relationships may be added to the product graph.

In the example shown, an identification of further suspected edges may be performed (step 1408). The identification of further suspected edges may be performed by using a link prediction algorithm based on graph neural networks (GNNs) to generate predicted edges. In particular, existing edges may be used as positive samples, and randomly selected negative sample edges between unlinked pairs of products within the product graph may be used as training data, and a GNN may then predict which product relationships are plausible despite a lack of, and add to cart data.

In the example shown, a set of bundles may be generated (step 1410). The bundle may be generated by first aggregating a set of recommended items. The recommended items may include all of the secondary products that have been identified. These can include the secondary products to which an edge exists from the initial product. The recommended items can also include secondary-similar products; that is, products identified as having an edge directed to them from a similar product to the initial product. The recommended items can further include inferred secondary items, for which edges are inferred from the initial product. The recommended items may also include, in some cases, inferred secondary-similar products, for which edges are inferred from the similar product.

Additionally, the set of bundles may be generated by applying one or more filters to the entire set of identified secondary products identified by edges that directly connect from the initial or seed product, edges that connect from a similar product to secondary products, and inferred edges from the initial product or complementary products. The filters may include price filters, and/or filters that exclude items from a bundling recommendation based on the secondary product having too high a degree of similarity to the initial product. A top predetermined number of products may then be returned, and displayed on the retail website as recommended products to the user (step 1412).

FIG. 15 illustrates a flow diagram of an example method 1500 of interacting with a user at a retail website to provide recommended products that may be bundled with a selected product. The method 1500 may be implemented at a computing system implementing a product bundles recommendation server, in accordance with embodiments described herein.

In the example shown, the method 1500 includes receiving a first product selection (step 1502). The first product selection may be received at a retail website.

In the example shown, the method 1500 includes identifying the first product in a product graph having pluralities of nodes and edges (step 1504). In examples, the product graph may be generated from historical add to cart data. The product graph may include a plurality of nodes and a plurality of edges, each ode corresponding to a different product, and each edge being a directed weighted edge connecting between a pair of nodes, and corresponding to an order and frequency in which two products that correspond to the pair of nodes were added to a shopping cart in the historical add to cart data. In some examples, the products represented by nodes within the product graph are within a common product category; in other examples, the products represented by nodes within the product graph are represented in at least two product categories. In some examples, the plurality of edges each have a weight that is normalized. In examples, an edge may be removed from the product graph based on a weight of the edge falling below a predetermined threshold.

In the example shown, the method 1500 includes identifying, in the product graph, edges from first product to one or more secondary/second products (step 1506).

In the example shown, the method 1500 includes identifying edges from a similar product to a secondary-similar product (step 1508). Based on a similar product to the first product existing within the product graph, one or more edges from the similar product to one or more secondary-similar products may be identified. In some examples, identifying the similar products within the product graph may be based, at least in part, on attributes of the products represented in the product graph.

In the example shown, the method 1500 includes identifying inferred edges from the first product and one or more inferred secondary products (step 1510). In some examples, determining the inferred edges between pairs of nodes in the product graph is based on a model trained using at least some of the plurality of edges as positive examples and node pairs lacking an edge therebetween as negative examples. In some examples, the model comprises a graph neural network (GNN).

In some examples, the method 1500 includes identifying, in the product graph, one or more inferred edges between the similar product and one or more inferred secondary-similar products, and including the one or more inferred secondary-similar products in the set of recommended products.

In the example shown, the method 1500 includes forming a set of recommended products (step 1512). The set of recommended products may be formed from at least some of the one or more secondary products, the one or more secondary-similar products, and the one or more inferred secondary products.

In the example shown, the method 1500 includes presenting at least one bundled product recommendation at a user interface (step 1514). The at least one bundled product recommendation may be included in a generated user interface that is displayed on the customer device as a recommendation for purchase with the initial product, the at least one bundled product recommendation being selected from among the set of recommended products.

In some examples, one or more filters may be applied to the set of recommended products to generate the at least one bundled product recommendation, the one or more filters being based, at least in part, on a price or a product diversity metric. In examples, such a product diversity metric determines a level of similarity between the first product and a selected one of the set of recommended products, the one or more filters excluding products from among the set of recommended products based on the product diversity metric falling within a threshold indicative of high product similarity.

In accordance with the present disclosure, and as reflected in the embodiments below, the present product bundles recommendation system has a number of technical advantages over existing systems as well as the efficiency advantages described above. In particular, referring to the Figures described herein, in particular the product bundles recommendation server, can allow retailers to provide broad or fine-grained control over product bundles recommended to consumers while they are shopping online on a retailer website. Specifically, a retailer may apply no filters, one filter, or multiple filters to a list of bundled products depending on the goals of the retailer. Additionally, the ability to train a model using known relationships between products to identify hidden links in a product relationship network and to infer complementary relationships between products is advantageous over existing systems for recommending products. By analyzing multi-step pathways between pairs of products that are connected by at least one complementary link or edge, additional complementary relationships can be inferred, which makes the present system more scalable and efficient than traditional systems. Furthermore, the present system incorporates an automated feedback data flow that returns to the product bundles recommendation server real-time updates to add to cart data, so the product bundles recommendation server can dynamically update a product relationship network defining product relationships as additional complementary relationships become known.

Additionally, by use of a product graph, similar item analysis, and identifying both direct and inferred items for the initial item and similar items, a broad range of potential bundled items may be identified and presented to the user, thereby increasing the likelihood that at least some such items may be selected for bundling. This increases user convenience of the user by quickly surfacing relevant items within a retail website while obtaining item relationships that might not otherwise have been apparent directly from the historical add to cart data.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein. Therefore, the specific structure, acts, or operations are disclosed only as illustrative aspects. The scope of the technology is defined by the following claims and any equivalents therein. Examples of the disclosure may be described according to the following aspects.

Aspect 1. A system for providing a product recommendation on a retailer website, the system comprising: a computing system including a data store, a processor, and a memory communicatively coupled to the processor, the memory storing instructions executable by the processor to: receive add to cart data, product price information, and product data for products offered at a retail website; form a product graph from the add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart; identify similar products within the product graph based, at least in part, on attributes of the products represented in the product graph; determine inferred edges between pairs of nodes in the product graph based on a model trained using at least some of the plurality of edges as positive examples and node pairs lacking an edge therebetween as negative examples; receive a selection of an initial product; identify, in the product graph: one or more edges from the initial product to one or more secondary products; based on a similar product to the initial product existing within the product graph, one or more edges from the similar product to one or more secondary-similar products; and one or more inferred edges from the initial product to one or more inferred secondary products; form a set of recommended products from at least some of the one or more secondary products, the one or more secondary-similar products, and the one or more inferred secondary products.

Aspect 2. The system of aspect 1, wherein the set of recommended products forms a list of bundled products, and wherein the system is further configured to present the at least one bundled product on a user interface on the customer device as a recommendation for purchase with the initial product.

Aspect 3. The system of any of aspects 1-2, wherein the set of recommended products is a subset of a collection formed by the one or more secondary products, the one or more secondary-similar products, and the one or more inferred secondary products, the subset formed based on application of a price filter.

Aspect 4. The system of any of aspects 1-3, wherein the set of recommended products is a subset of a collection formed by the one or more secondary products, the one or more secondary-similar products, and the one or more inferred secondary products, the subset formed based on application of a similarity filter to exclude from the set of recommended products those products having a degree of similarity to the initial product that is above a threshold level of similarity.

Aspect 5. The system of any of aspects I-4, wherein the model comprises a graph neural network (GNN).

Aspect 6. The system of any of aspects 1-5, wherein the products offered at a retail website include a plurality of products within a product category, and wherein the product graph is formed from items within the product category.

Aspect 7. A method comprising: receiving a selection of a first product at a retail website; identifying the first product in a product graph generated from historical add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart in the historical add to cart data; identifying, in the product graph: one or more edges from the first product to one or more secondary products; based on a similar product to the first product existing within the product graph, one or more edges from the similar product to one or more secondary-similar products; and one or more inferred edges from the first product to one or more inferred secondary products; forming a set of recommended products from at least some of the one or more secondary products, the one or more secondary-similar products, and the one or more inferred secondary products; and presenting at least one bundled product recommendation on a user interface on the customer device as a recommendation for purchase with the initial product, the at least one bundled product recommendation being selected from among the set of recommended products.

Aspect 8. The method of aspect 7, further comprising: identifying the similar products within the product graph based, at least in part, on attributes of the products represented in the product graph; and determining the inferred edges between pairs of nodes in the product graph based on a model trained using at least some of the plurality of edges as positive examples and node pairs lacking an edge therebetween as negative examples.

Aspect 9. The method of aspect 8, wherein the model comprises a graph neural network (GNN).

Aspect 10. The method of any of aspects 7-9, further comprising applying one or more filters to the set of recommended products to generate the at least one bundled product recommendation, the one or more filters being based, at least in part, on a price or a product diversity metric.

Aspect 11. The method of aspect 10, wherein the product diversity metric determines a level of similarity between the first product and a selected one of the set of recommended products, the one or more filters excluding products from among the set of recommended products based on the product diversity metric falling within a threshold indicative of high product similarity.

Aspect 12. The method of any of aspects 7-11, wherein the products represented by nodes within the product graph are within a common product category.

Aspect 13. The method of any of aspects 7-12, wherein the plurality of edges each have a weight that is normalized.

Aspect 14. The method of aspect 13, further comprising removing an edge from the product graph based on a weight of the edge falling below a predetermined threshold.

Aspect 15. The method of any of aspects 7-14, further comprising, identifying in the product graph one or more inferred edges between the similar product and one or more inferred secondary-similar products and including the one or more inferred secondary-similar products in the set of recommended products.

What is claimed is:

1. A system for providing a product recommendation on a retailer website, the system comprising:
a computing system including a data store, a processor, and a memory communicatively coupled to the processor, the memory storing instructions executable by the processor to:
receive add to cart data, product price information, and product data for products offered at a retail website;
form a product graph from the add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart;
identify similar products within the product graph based, at least in part, on attributes of the products represented in the product graph;
determine inferred edges between pairs of nodes in the product graph based on a model trained using at least some of the plurality of edges as positive examples and node pairs lacking an edge therebetween as negative examples;
receive a selection of an initial product;
identify, in the product graph:
one or more edges from the initial product to one or more secondary products;
based on a similar product to the initial product existing within the product graph, one or more edges from the similar product to one or more secondary-similar products; and
one or more inferred edges from the initial product to one or more inferred secondary products;
form a set of recommended products from at least some of the one or more secondary products, the one or more secondary-similar products, and the one or more inferred secondary products.

2. The system of claim 1, wherein the set of recommended products forms a list of bundled products, and wherein the system is further configured to present the at least one bundled product on a user interface on the customer device as a recommendation for purchase with the initial product.

3. The system of claim 1, wherein the set of recommended products is a subset of a collection formed by the one or more secondary products, the one or more secondary-similar products, and the one or more inferred secondary products, the subset formed based on application of a price filter.

4. The system of claim 1, wherein the set of recommended products is a subset of a collection formed by the one or more secondary products, the one or more secondary-similar products, and the one or more inferred secondary products, the subset formed based on application of a similarity filter to exclude from the set of recommended products those products having a degree of similarity to the initial product that is above a threshold level of similarity.

5. The system of claim 1, wherein the model comprises a graph neural network (GNN).

6. The system of claim 1, wherein the products offered at a retail website include a plurality of products within a product category, and wherein the product graph is formed from items within the product category.

7. A method comprising:
receiving a selection of a first product at a retail website;
identifying the first product in a product graph generated from historical add to cart data, the product graph including a plurality of nodes and a plurality of edges, each node corresponding to a different product, and each edge being a directed weighted edge connecting between a pair of nodes and corresponding to an order and frequency in which two products corresponding to the pair of nodes were added to a shopping cart in the historical add to cart data;
identifying, in the product graph:
one or more edges from the first product to one or more secondary products;
based on a similar product to the first product existing within the product graph, one or more edges from the similar product to one or more secondary-similar products; and
one or more inferred edges from the first product to one or more inferred secondary products;
forming a set of recommended products from at least some of the one or more secondary products, the one or more secondary-similar products, and the one or more inferred secondary products; and
presenting at least one bundled product recommendation on a user interface on the customer device as a recommendation for purchase with the initial product, the at least one bundled product recommendation being selected from among the set of recommended products.

8. The method of claim 7, further comprising:
identifying the similar products within the product graph based, at least in part, on attributes of the products represented in the product graph; and
determining the inferred edges between pairs of nodes in the product graph based on a model trained using at least some of the plurality of edges as positive examples and node pairs lacking an edge therebetween as negative examples.

9. The method of claim 8, wherein the model comprises a graph neural network (GNN).

10. The method of claim 7, further comprising applying one or more filters to the set of recommended products to generate the at least one bundled product recommendation, the one or more filters being based, at least in part, on a price or a product diversity metric.

11. The method of claim 10, wherein the product diversity metric determines a level of similarity between the first product and a selected one of the set of recommended products, the one or more filters excluding products from among the set of recommended products based on the product diversity metric falling within a threshold indicative of high product similarity.

12. The method of claim 7, wherein the products represented by nodes within the product graph are within a common product category.

13. The method of claim 7, wherein the plurality of edges each have a weight that is normalized.

14. The method of claim 13, further comprising removing an edge from the product graph based on a weight of the edge falling below a predetermined threshold.

15. The method of claim 7, further comprising, identifying in the product graph one or more inferred edges between the similar product and one or more inferred secondary-similar products and including the one or more inferred secondary-similar products in the set of recommended products.
